(19) United States
(12) Patent Application Publication
(10) Pub. No.: US 2006/0133954 A1
(43) Pub. Date: Jun. 22, 2006

(54) Resuspension of magnetizable particles

(75) Inventors: Hartmut Richard Schroeder, Franklin, MA (US); Eugene K. Achter, Lexington, MA (US)

Correspondence Address: KIRKPATRICK & LOCKHART NICHOLSON GRAHAM LLP, STATE STREET FINANCIAL CENTER, ONE LINCOLN STREET, BOSTON, MA, 02111-2950, US

(73) Assignee: Instrumentation Laboratory Company, Lexington, MA (US)

(21) Appl. No.: 11/300,956

(22) Filed: Dec. 15, 2005

Related U.S. Application Data
(60) Provisional application No. 60/637,946, filed on Dec. 21, 2004.

(51) Int. Cl. B01L 3/00

(52) U.S. Cl. 422/61; 366/273; 422/82.05; 422/99

(57) ABSTRACT

A kit for clinical analysis, including a vessel containing magnetizable particles and a magnetic stirring element. A device for distributing magnetizable particles in a fluid including a platform for supporting a vessel containing a fluid, magnetizable particles, and a magnetic stirring element, where the magnetic stirring element moves in a horizontal plane within the vessel. A method for distributing magnetizable particles in a fluid including the steps of providing a vessel containing a magnetic stirring element and a fluid containing magnetizable particles, moving the magnetic stirring element in the vessel, and distributing the magnetizable particles in the fluid.

### RELATED APPLICATIONS

This application claims priority to U.S. Provisional Patent Application Ser. No. 60/637,946, filed Dec. 21, 2004, the entire disclosure of which is herein incorporated by reference.

### TECHNICAL FIELD OF THE INVENTION

This invention relates to clinical diagnostic assays, in particular, immunoassays utilizing magnetizable particles, kits, and methods thereof.

### BACKGROUND OF THE INVENTION

Immunoassays, such as chemiluminescent immunoassays, generally require two antibody preparations, a first antibody used to capture and immobilize a target antigen molecule, and a second antibody used to attach a detection label to the antigen.

Immobilization of an antigen to be detected in an immunoassay may be accomplished using magnetizable particles, and detection may be accomplished by using a suitable tracer such as isoluminol chemiluminescence. The assay involves the following major steps. For example, a sample containing the antigen is mixed with a first antibody to the antigen which is coupled to magnetizable particles, and the mixture is allowed to react. Generally, a wash step follows to remove unbound sample and other interfering reagents. A second antibody, typically directed against a different epitope on the antigen, coupled to isoluminol, is added to the washed particles in step 1 and the mixture is allowed to react. A magnetic field is applied to retain magnetizable particles (with antigen bound, labeled antibody) against the inside wall of the container. A wash fluid is introduced to remove the unbound labeled antibody. Washing the magnetizable beads typically occurs by immobilizing the beads in the magnetic field, introducing a wash fluid, removing the magnetic field, and repeatedly expelling beads into and aspirating the beads from a container to recover all of the beads and to homogeneously mix and resuspend the beads in the wash fluid. The magnetizable beads with antigen bound, labeled antibody are resuspended in an appropriate fluid in a suitable optical cuvette. An activating reagent such as hydrogen peroxide and a catalyst/co-oxidant, which activates isoluminol, is added with the beads in the cuvette and light is emitted in a chemiluminescent reaction. The light emitted from the chemiluminescent reaction is detected using a suitable photodetector. For some applications, additional steps of reagent addition and/or washing may be necessary.

One of the problems in the use of magnetizable particles in diagnostic assays is that the particles tend to settle and aggregate and are not always readily uniformly resuspendable. The lack of uniform suspension of the particles introduces errors when a sample of the resuspended beads is relied on to provide a reliable indication of the quantity or quality of a target antigen in the sample undergoing analysis.

Current methods of resuspending magnetizable particle reagents prior to sampling include multiple hand inversions of the container holding the particles, mechanical agitation other than by a magnet such as by vortexing, or by periodic sonication of the particles. These methods can result in non-uniform resuspension and often generate air bubbles in the reagent fluid in which the particles are suspended. Air bubbles must be removed by pipette prior to reagent sampling, an inconvenient process that can result in loss of reagent.

Moreover, with present methods used to resuspend-magnetizable particles in a fluid medium, a moderate to deep meniscus is generated. A moderate to deep meniscus at the surface of the fluid medium from the top of the fluid to the bottom of the vessel in a reaction vessel lowers the depth of fluid medium in the vessel. As a result of this lower depth, a greater volume of fluid medium will be inaccessible to the sampling end of a sample probe used to sample some or all of the fluid medium in the vessel.

Magnetizable particles typically consist of a mixture of magnetite and non-magnetic material. Magnetizable particles that are useful for clinical diagnostic assays have functional groups distributed on the surface of the particles for attachment of target proteins or other target analytes in the test sample. The amount of magnetite present in the magnetizable particles dominates the density and magnetic susceptibility of the particles. Density and size of the magnetizable particles, typically 0.1 to 100 μm in diameter, determine the rate of settling of the particles.

### SUMMARY OF THE INVENTION

In one aspect, the invention described herein features a kit for clinical analysis of one or more analytes, such as an antigen, in a sample, typically a fluid sample, from a patient. In one embodiment, the kit includes a vessel containing magnetizable particles and a magnetic stirring element. In another embodiment, the kit further includes a fluid medium. In yet another embodiment, the kit further includes one or more reagents, such as an antibody, a portion of an antibody, or a tracer, for example, that may be bound to the magnetizable particles. The kit is used for analyzing fluids, such as body fluids, for example, blood, serum, plasma, urine, cerebrospinal fluid, fluid from the digestive or respiratory tract, or joint fluid, in assays using magnetizable particles. In one embodiment of the invention, the magnetizable particles are reversibly bound to the magnetic stirring element to prevent reagent degradation when the magnetizable particles are shipped in a reagent fluid.

In another aspect, the invention features a device for distributing magnetizable particles in a sampled body fluid from a patient for clinical analysis of one or more analytes such as an antigen, in the patient's body fluid. The device includes a platform for supporting a vessel containing a fluid of magnetizable particles, and a magnetic stirring element disposed in the vessel. The platform includes a magnetic field driver that moves the magnetic stirring element, for example, in a horizontal plane within the vessel such as by rotation. The device also includes a vessel transport rack and a reagent transfer probe. The magnetic stirring element is generally rod-shaped, has a smooth outer surface that may or may not contain a coating of glass or polytetraflouroethylene, and has winged, round, triangular, or square ends, or the stirring element may be dumbell-like in shape.

In one embodiment, the magnetic stirring element has a configuration particularly suited for resuspension of magnetizable particles in a vessel. The magnetic stirring element generally has a diameter of about 3% to about 15% of its length, more preferably about 5% to about 8% of its length. The magnetic stirring element also has a length that is about 60% to about 95% of the cross-sectional dimension of the vessel, more preferably about 70% to about 80% of the cross-sectional dimension of the vessel. The magnetic stirring element has a magnetic strength of about 2000 to about 13,000 Gauss, more preferably about 8000 to about 10,000 Gauss.

In one aspect, the invention features a method for distributing magnetizable particles in a fluid. The method includes the steps of providing a vessel containing a magnetic stirring element and a fluid containing magnetizable particles, moving the magnetic stirring element in the vessel, and distributing the magnetizable particles in the fluid. The method further includes applying a magnetic field to the magnetic stirring element in the vessel to rotate the magnetic stirring element and resuspend the magnetizable particles in the fluid. The method further includes performing an immunoassay wherein the method of distributing the magnetizable particles in a fluid and performing an immunoassay is automated and controlled by a computer.

### BRIEF DESCRIPTION OF THE FIGURES

In the drawings, like reference characters generally refer to the same parts throughout the different views. Also, the drawings are not necessarily to scale or proportion, emphasis instead generally being placed upon illustrating the principles of the invention.

FIG. 1 is a schematic drawing of a device for distributing magnetizable particles in a fluid according to an illustrative embodiment of the invention.

FIG. 2 is a schematic drawing of a kit prior to resuspension of the magnetizable particles according to an illustrative embodiment of the invention.

FIG. 3 is a schematic top view of the kit illustrated in FIG. 2.

FIG. 4 is a schematic cross-sectional view of a diameter of a magnetic stirring element according to an illustrative embodiment of the invention.

FIG. 5 is a table depicting data of resuspension trials performed using commercially available magnetic stirring elements.

FIG. 6 is a table depicting data of resuspension trials performed using modified magnetic stirring elements according to the invention.

### DESCRIPTION OF THE INVENTION

The invention, described herein, is a device, such as a clinical analytical instrument, including a magnetic stirring element for use in analyzing fluids, such as body fluids, for example, blood, serum, plasma, urine, cerebrospinal fluid, joint fluid, fluid from the respiratory tract, fluid from the digestive tract, and aspirates in assays using magnetizable particles, e.g., magnetizable beads. The embodiments of the invention described below have the following common features: a vessel containing a magnetic stirring element and magnetizable particles.

As used herein, the term magnetic stirring element means a permanent magnet, the term magnetic field driver means having a permanent magnetic moment or electromagnet, and the term magnetizable means being attracted by a magnet. For example, magnetizable refers to particles including iron, cobalt, and nickel. The term resuspend as defined herein means substantially uniform distribution of magnetic particles in a fluid.

In general, in one respect, the invention provides a device for the clinical analysis of fluids, such as detecting one or more analytes in a body fluid, having a vessel that contains a magnetic stirring element that serves to mix, stir, resuspend, distribute, agitate or otherwise manipulate magnetizable particles, such as beads, to resuspend the magnetizable particles in a fluid medium in a short period of time. The force, for example, the rotational speed of the magnetic stirring element, required to resuspend the magnetizable particles according to the invention generates only a shallow meniscus at the surface of the fluid medium. Analytes that may be detected according to the invention include but are not limited to peptides, proteins, antibodies, nucleic acids, pathogens, and fragments of any of the aforementioned analytes. Additionally, the invention may be used to immobilize an antibody to provide a binding reagent in, for example, an immunoassay, cell fractionations, protein purification procedures, ligand capture, or for nucleic acid hybridization procedures.

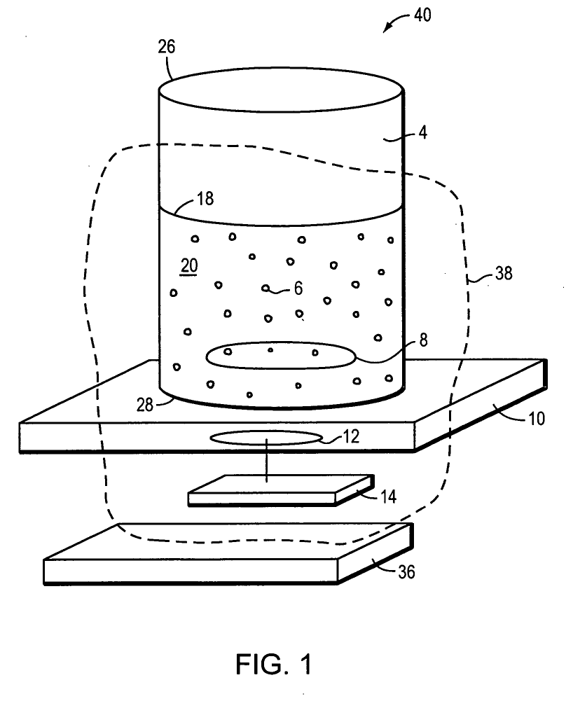

FIG. 1 is a schematic drawing of a device 40 for distributing magnetizable particles in a fluid according to an illustrative embodiment of the invention. The illustrative device 40 includes a platform 10 for supporting a vessel 4. The vessel 4 contains a fluid medium 20, a plurality of magnetizable particles 6, and a magnetic stirring element 8. The platform 10 contains a magnetic field generator 36 that rotates the magnetic stirring element 8. According to one embodiment of the invention, the magnetic field 38 is generated in a short period of time by a magnet 12 that is moved, e.g., rotated, by a motorized driver 14. In another embodiment, the magnetic field 38 is generated by a magnetic field driver 36, comprising four quadrants of magnetic coils placed between two plates. The device 40 substantially uniformly resuspends the magnetizable particles 6 in the fluid medium 20 in the vessel 4.

The device 40 according to the invention may also feature (not shown) a rack for holding sample vessels, multi-well sample vessels, one or more reagent transferring probe, one or more wash fluid probes and one or more reagent packs for one or more immunoassay procedures. In one embodiment, the rack (not shown) holds multiple sample vessels and adapts to accommodate vessels of varying dimensions. The reagent transferring probe moves, for example, in x, y, and z directions, collects reagent from a reagent pack and delivers the reagent to the sample vessel 2. The reagent packs (not shown) contain reagents for analyzing an analyte, such as, for example, an immunoassay, and are maintained, for example, at a temperature in the range of about 10°-25° C., alternatively 15-22° C., or 15° C. In one embodiment according to the invention, each reagent pack contains all of the reagents necessary for a particular assay. The device 40 may further feature a processor such as a computer for automating, sequencing and controlling all of the steps necessary for analyzing an analyte, such as all of the steps in an immunoassay.

In a particular embodiment, the vessel 4, illustrated in FIG. 1, is manufactured from non-magnetic materials such as glass, plastic, ceramics, composite materials, metals, metal alloys, or other suitable materials. The vessel 4 may be manufactured from one material and clad in another material or may be made from multiple layers of the same material. Typically the vessel 4 is a cylinder with an open top 26 and a sealed bottom 28. The vessel 4 may have other shapes (not shown), such as the sides of the vessel 4 may be parallel or non-parallel, or may have a waist, flare, or indentations for interfacing with, for example, another instrument. The top 26 or the rim 26 of the vessel 4 may include features (not shown), e.g., threads, knobs, shoulders, flanges, slots, lips, perforations or other protrusions for engaging a lid (not shown). Embodiments of the invention shown in the figures are only illustrative of the invention and are not meant to be limiting.

The fluid medium 20 in one embodiment is a solution, e.g., a solution of water, or alternatively, a solvent, e.g., alcohol. The fluid medium 20 in which the magnetizable particles 6 are suspended may include a body fluid, such as, for example, blood, serum, plasma, urine, cerebrospinal fluid, joint fluid, fluid from the respiratory tract, fluid from the digestive tract, and aspirates, containing an analyte of interest, for example but not limited to D-Dimer, troponin-I, von Willebrand Factor (vWF), human chorionic gonadotropin (HCG), or C-reactive protein (C-RP). In another embodiment, the fluid medium 20 is a wash fluid, a diluent, or a fluid containing a reagent, for example lectins, a tracer such as acridinium ester, fluorescein, rhodamine, gold particles, horseradish peroxidase, isoluminol, glucose oxidase, alkaline phosphatase, a labeled molecule such as labeled biotin, labeled avidin, a labeled antibody, an unlabeled antibody, variants thereof, fragments thereof or other compounds directed to the analyte of interest.

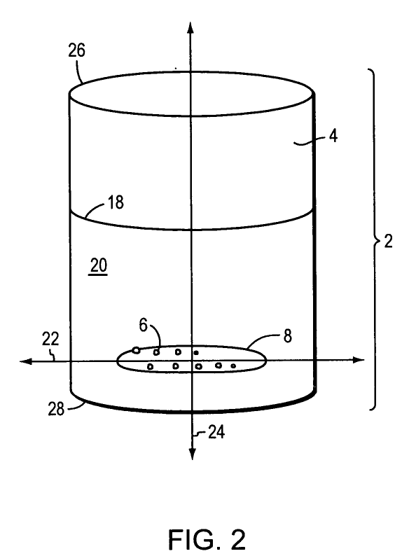

FIG. 2 is a schematic drawing of a kit prior to resuspension of the magnetizable particles including a vessel 4, magnetizable particles 6, a magnetic stirring element 8, and a fluid medium 20 such as a reagent, or a diluent, for example, according to an illustrative embodiment of the invention. The illustrative magnetic stirring element 8 is a smooth rod-shaped cylinder. Alternatively, the magnetic stirring element 8 may have a variety of shapes, including cylindrical, rectangular, or oval, or may have a pentagonal, hexagonal, octagonal, or other cross-sectional 34 shape. In yet another embodiment, the magnetic stirring element 8 may have a variety of end shapes to improve distribution of the magnetizable particles 6 at the edges of the vessel 4. End shapes of the magnetic stirring element 8 include, for example, round, square, triangular, or winged.

In yet another embodiment, the magnetic stirring element 8 is dumbell-shaped, in which a portion of the ends of the magnetic stirring element 8 are larger in diameter than the center of the magnetic stirring element 8, to facilitate rotation of the magnetic stirring element 8 in a vessel 4 having a raised center at the bottom 28 of the vessel 4.

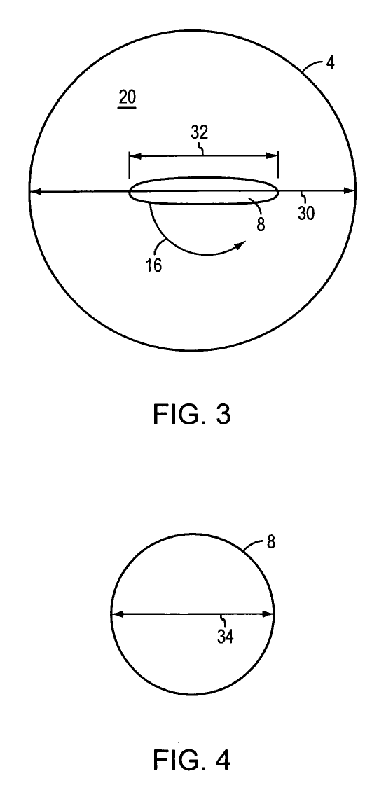

FIG. 3 is a schematic top view of the kit illustrated in FIG. 2. In one embodiment, the length 32 of the magnetic stirring element 8 is in the range of about 60% to about 95% of the diameter 30 of the vessel 4, preferably the length 32 is in the range of about 70% to about 80% of the diameter 30.

FIG. 4 is a schematic cross-sectional view of the diameter of a magnetic stirring element 8. In one embodiment, the cross-sectional width 34 of the magnetic stirring element 8, shown in FIG. 4, for example, is in the range of about 3% to about 15% of the length 32 of the magnetic stirring element 8, shown in FIG. 3, for example. Preferably the cross sectional width 34 is in the range of about 5% to about 8% of the length 32 of the magnetic stirring element 8.

With continued reference to FIG. 3, in one embodiment, the magnetic stirring element 8 has a magnetic strength in the range of about 2,000 Gauss to about 13,000 Gauss, preferably in the range of about 8000 Gauss to about 10,000 Gauss. The magnetic stirring element 8 may be made from iron, chromium, cobalt, neodymium, or samarium, or their combination, for example. In one embodiment, the magnetic stirring element is made from an alloy composed of about 60% to about 77% iron, about 26% to about 30% chromium, and about 7% to about 10% cobalt, for example. The magnetic stirring element 8 may also be made from an alloy of neodymium or an alloy of samarium.

In a particular embodiment, the cross-sectional width 34 of the magnetic stirring element 8 is 6.6% to 8% of the length 32 of the magnetic stirring element 8, the length 32 of the magnetic stirring element 8 is 79% of the diameter 30 of the vessel 4 having an internal diameter of 19 mm, and the magnetic stirring element 8, has a magnetic strength of 9,000 Gauss, and a square end-shape.

In one embodiment according to the invention, the magnetic stirring element 8 is corrosion-resistant and includes a smooth outer surface. In another embodiment, the magnetic stirring element 8 includes a thin coating on the outer surface of the magnetic stirring element 8 to reduce friction and to prevent corrosion. The coating may be, for example, glass, polytetraflouroethylene, or other suitable materials. The depth of the coating is uniform, for example, along the length of the magnetic stirring element 8 to prevent non-uniform retention of magnetizable particles 6 and/or to prevent variable shear forces during manipulation of the magnetic stirring element 8, e.g., stirring. Uniform coatings applied to the outer surface of the magnetic stirring element 8 having the shape and dimension described herein enable resuspension of the magnetizable particles 6 at low or moderate rates of rotation, for example at rates of rotation ranging from about 150 RPM to about 720 RPM, preferably 360 RPM. These rates of rotation are sufficiently low to avoid destruction of reagents in the fluid medium 20, uneven resuspension of magnetizable particles 6, and generation of a moderate to deep meniscus 18 in the fluid medium 20 contained within the vessel 4.

The magnetizable particles 6 according to the invention are made from a material that is attracted to a magnet. Such materials include, for example, iron, iron oxide, nickel, cobalt, and other suitable materials. According to one embodiment of the invention, one or more antibodies, portions of an antibody, other binding agents, for example, labeled or unlabeled avidin or biotin, or tracers, for example, acridinium ester, fluorescein, rhodamine, gold particles, isoluminol, glucose oxidase, or alkaline phosphatase, may be attached to the particle 6.

In a particular embodiment, the magnetizable particle 6 is a magnetizable latex particle having an iron oxide core surrounded by a polystyrene shell that is coated with a polymer bearing functional groups to which an antibody, fragments, or variants thereof, can be attached, for example, 2.8 μm Dynabeads™ M-280 Sheep anti Mouse IgG, (DYNAL, Inc., Lake Successful, N.Y.). Alternatively, the magnetizable particles 6 may be paramagnetic particles, typically 0.1-100 μm, preferably 1-20 μm, in size having a composition including iron oxides and various other materials, e.g., polystyrene, agarose or cellulose, which may also have functional groups, e.g., aminosilanes or hydroxylated polymers, for antibody attachment (Advanced Magnetics, Inc., Cambridge, Mass.).

Excessive resuspension time or excessive rate of rotation used to resuspend the magnetizable particles may destroy or remove the bound reagents from the magnetizable particles. Following destruction or removal of bound reagents, a standard sample of magnetizable particles 6 will contain fewer bound reagent sites and, therefore, will bind less analyte of interest. The analyte of interest that interacts with an unbound reagent will be aspirated and disposed of in the fluid medium 20 during intermediate magnetic capture and wash steps. As a result, a sample of magnetizable particles 6 removed by a sample probe for analysis will contain less analyte of interest, thereby binding less tracer (labeled antibody), hence producing less signal and a diminished sample value.

With reference to the illustrative embodiment in FIG. 1, the device may further include a platform 10 on which the vessel 4 is supported. The platform 10 features a magnetic field generator 36 that generates a magnetic field 38 to rotate the magnetic stirring element 8 in the vessel 4. In one embodiment, the magnetic field generator 36 is generated by an alternating magnetic field driver 36 located within the platform 10. The alternating magnetic field driver 36 advances the magnetic stirring element 8 by periodically applying electricity to four magnetic coils (not shown) arranged in quadrants. Two coils located in opposing quadrants are aligned to generate a magnetic north and the other two opposing coils are aligned to generate a magnetic south. Periodic generation of magnetism in the four quadrants creates a magnetic field 38 that moves the magnetic stirring element 8. In another embodiment, the magnetic field 38 is generated by a magnetic field generator 36 including magnet 12 that is rotated using, for example, a rotating motor 14. In another embodiment, the magnetic field 38 is generated using a combination of methods, including an alternating magnetic field driver 36 and a moving magnet 12. According to one embodiment of the invention, the magnetic stirring element 8 is rotated in a plurality of directions, including at least clockwise and counterclockwise rotation. According to another embodiment of the invention, the magnetic stirring element 8 is rotated in either a clockwise or counterclockwise rotation.

Referring again to FIG. 2, when rotated, the magnetic field 38, shown in FIG. 1, generated by the magnetic field generator 36, shown in FIG. 1, extends along the vertical axis 24 of the vessel 4, while the magnetic stirring element 8 rotates in a horizontal plane 22 of the vessel 4, perpendicular to the vertical axis 24 of the vessel 4 at rates of rotation ranging from about 150 RPM to 720 RPM, preferably about 360 RPM.

With continued reference to FIG. 2, according to one embodiment of the invention, a kit 2 includes a vessel 4, having a vertical axis 24, a magnetic stirring element 8 and magnetizable particles 6. In another embodiment, the kit 2 further includes a fluid medium 20. The kit 2 may be used to perform clinical or analytical assays, including, for example, an immunoassay, to detect or to measure the quantity of an analyte in a body fluid from a patient.

In one embodiment according to the invention, the magnetizable particles 6 are used to separate a reagent or component participating in a reaction in a fluid. For example, according to the invention an enzyme immobilized on a magnetizable particle 6 may be easily separated from a suspension after the enzyme has converted substrate to product. Additionally, magnetizable particles 6 have been especially useful for immobilizing an antibody to provide a binding reagent in an immunoassay, cell fractionations, protein purification procedures, ligand capture, or for nucleic acid hybridization procedures.

According to one embodiment of the invention, the magnetizable particles consist of a mixture of magnetite and non-magnetic material. In another embodiment, the magnetizable particles range in size from 0.1 μm to 100 μm, preferably 0.5 μm to 3.5 μm, more preferably 2.8 μm in diameter and further include functional groups, e.g., carboxyl, amino, or hydroxyl groups, for attachment of proteins. The amount of magnetite in the magnetizable particles determines the density and magnetic susceptibility of the magnetizable particles. Magnetizable particles 2.8 μm diameter (DYNAL) bind to the poles of the magnetic stirring element 8 and are attracted to the bottom of the vessel 4, concentrating where the magnetic field 36 below is the greatest. Furthermore, about 2 percent of the total concentration of magnetizable particles 2.8 diameter (DYNAL) settle to the bottom of the vessel 4 per minute by gravity alone.

According to one embodiment of the invention, the magnetic stirring element 8 may be added to the vessel 4 containing the magnetizable particles 6 just before loading the kit 2 on the instrument platform 10. Alternatively, the kit 2 may be shipped from the manufacturer to the customer with the magnetizable particles 6 and the magnetic stirring element 8 contained within the vessel 4. In one embodiment, the vessel further includes a fluid medium. Reagents, for example, antibodies, that are bound to the magnetizable particles 6 are protected from degradative shear forces that may occur during shipment when the magnetic stirring element and magnetizable particles are within the vessel because the magnetizable particles 6 attach to the magnetic stirring element 8 thereby minimizing shear forces on the magnetizable particles. Initial resuspension of the magnetizable particles 6 that are shipped in the vessel 4 with the magnetic stirring element 8 in the kit 2 is aided because the magnetizable particles 6 in the kit 2 tend to adhere to the magnetic stirring element 8 rather than to settle at the edges of the vessel 4. The magnetizable particles 6 adhered to the magnetic stirring element 8 are easily detached at relatively low centrifugal force generated by slow rotation of the magnetic stirring element 8 as compared to magnetic particle 6 that are shipped in the vessel 4 without the magnetic stirring element 8 which aggregate on the bottom of the vessel 4 or wedge at the edges of the bottom of the vessel 4.

### EXAMPLES

In each of the following examples, a magnetic stirring element 8 was added to 2 mL or 8 mL of the fluid medium 20. The fluid medium 20 consisted of a freshly mixed suspension of 1 mg/mL magnetizable particles 6 (2.8 μm, DYNAL), 1 mg/mL bovine serum albumin (BSA), 50 mM phosphate, 150 mM sodium chloride, and 0.1% sodium azide. The fluid medium 20 was placed in a 10 mL reaction vessel 4 according to the invention illustrated in FIG. 1 and described in the corresponding text. The reaction vessel 4 was placed in a rack in the reagent stir area of an ACL-TOP analytical instrument (Instrumentation Laboratory Company, Lexington, Mass.). After stirring for a specified time ranging from seconds to hours at rotation speeds ranging from 360 RPM to 409 RPM, 50 μL aliquots of the fluid medium 20 containing the magnetizable particles 6 were sampled with an automated sample probe while the fluid medium 20 was stirred with the horizontally rotating magnetic stirring element 8. Each sample was then diluted with an additional 150 μL buffer. The absorbance at 500 nm of each sample was measured in a spectrophotometer [Cary 3-Bio-UV-Visible Spectrophotometer, Varian, Palo Alto, Calif.]. Results were expressed as a percentage of the absorbance of the sample obtained following stirring, compared to the absorbance of an aliquot of the initial suspension diluted similarly (resuspension rates). Two experiments were conducted: one with commercially available magnetic stirring elements and one with custom designed magnetic stirring elements, as described below in greater detail.

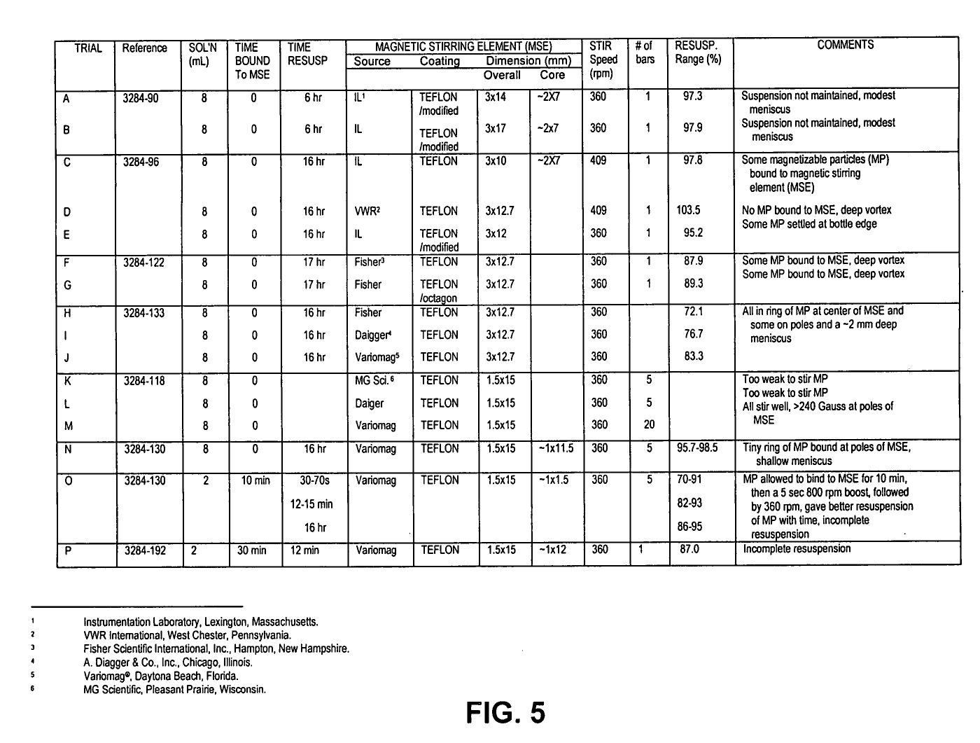

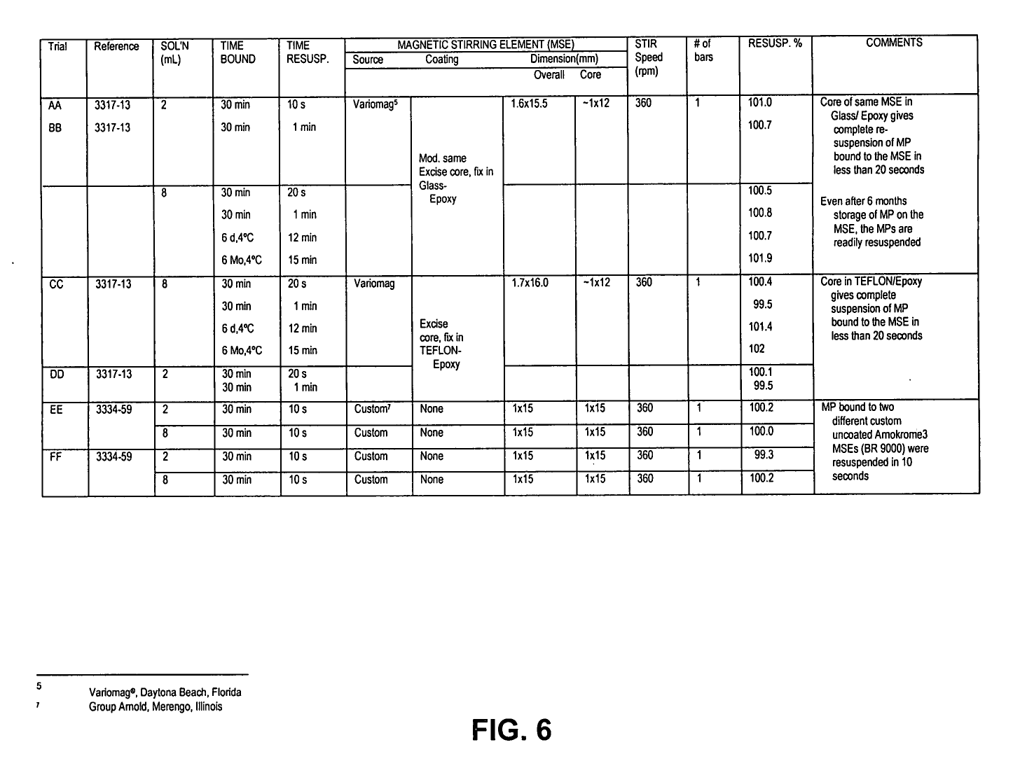

A variety of magnetic stirring elements from several vendors were tested as provided by the vendors or as modified. A 10 mL vessel 4 according to the invention with an inside diameter of about 19 mm was filled to varying fluid medium depth levels with the fluid medium, described above. The volume of the fluid medium 20 ranged from 2 to 8 mL as indicated below in FIG. 5 and FIG. 6.

Commercially Available Magnetic Stirring Elements.

FIG. 5 is a table depicting data of resuspension trials performed using commercially available magnetic stirring elements. The commercially available magnetic stirring elements were of various length and width dimensions, of various shapes, including octagonal, cylindrical and modified. Some magnetic stirring elements included a Teflon® coating (E.I. du Pont de Nemours and Co., Wilmington, Del.). Although some of the commercially available magnetic stirring elements achieved resuspension rates of 97% or better, the commercially available magnetic stirring elements required a resuspension time of 6 hours to 17 hours to achieve these resuspension rates. A resuspension time of 6 to 17 hours is impractical for a clinical analysis.

With continued reference to FIG. 5, in an initial trial (FIG. 5, Trial C), a 3×10 mm commercially available magnetic stirring element was used to resuspend the magnetizable particles. Magnetizable particles adhered to the magnetic stirring element and other particles collected on the bottom edge of the vessel. Resuspension of the particles was about 97.8% after 16 hours stirring.

In subsequent trials (FIG. 5, Trials D-G), longer commercially available magnetic stirring elements, particularly a 3×12.7 mm magnetic stirring element, were tested. The 3×12.7 mm magnetic stirring element had a strong magnetic field that resulted in the collection of magnetizable particles near the middle and at the poles of the magnetic stirring element. Unacceptable resuspension rates as low as 72% after 16 or 17 hours of stirring were achieved. Furthermore, longer magnetic stirring elements (FIG. 5, Trials H-J) increased the depth of the meniscus of the fluid medium by at least 2 mm when a stir speed of 360 RPM was employed. Such meniscus depths are unacceptable for clinical analysis because a greater sample volume becomes inaccessible by the sample probe.

In additional trials (FIG. 5, Trials A-B) longer commercially available magnetic stirring elements were modified by placing the magnetic cores inside 3×14 mm or 3×17 mm Teflon® housings. These modifications resulted in an improved resuspension rate of 97% to 98% after 6 hours of stirring, however, stirring for 6 hours is impractical for clinical analyses. Moreover, the magnetizable particles settled rapidly in these samples after stirring was stopped.

In the next trial (FIG. 5, Trial N), five 1.5×15 mm commercially available magnetic stirring elements were tested. These magnetic stirring elements maintained 96% to 98% suspension when added to the solution just prior to resuspension, bound only a few magnetizable particles at the poles, and produced a very shallow meniscus. However, in a subsequent trial (FIG. 5, Trial O), when the magnetizable particles were allowed to bind to the magnetic stirring element first and then subsequently placed on the stir platform, initial resuspension was low at 70% to 91% after 30 to 70 seconds of stirring. The percentage of resuspension increased to 82% to 93% after 12 to 15 minutes, but even after 16 hours of stirring, a length of time impractical for clinical applications, the sample only reached a resuspension percentage of 86% to 95%. Additionally, the 1.5×15 mm magnetic stirring elements (FIG. 5, Trials M-O) had Teflon® coatings that were non-uniform. The non-uniform Teflon® coating allowed focal areas of stronger magnetism along the magnetic stirring element which retained more magnetizable particles than other areas of the magnetic stirring element. Some of the coatings were also rough, which increased the shear force necessary to remove the magnetizable particles from the magnetic stirring element. Furthermore, some of the commercially available magnetic cores were not evenly cut and pointed, again leading to locally strong magnetism on the surface of the magnetic stirring element.

Commercially available 1.5×15 mm magnetic stirring elements, obtained from other sources, were too weak to even stir the fluid containing the magnetizable particles (FIG. 5, Trials K-L).

Custom Designed Magnetic Stir Bars.

FIG. 6 is a table depicting data of resuspension trials performed using modified and custom magnetic stirring elements. The modified magnetic stirring elements are constructed of an excised magnetic core fixed in a coating of either glass/epoxy (FIG. 6, Trials AA-BB) or Teflon®/epoxy (FIG. 6, Trials CC-DD). The custom magnetic stirring elements (FIG. 6, Trials EE-FF) contained no outer coating. The modified and custom magnetic stirring elements achieved resuspension rate of at least 99.3% in as little as 10 seconds. Some achieved adequate resuspension rates even after being stored with magnetizable particles bound to the magnetic stirring elements for as long as 6 months prior to resuspension (FIG. 6, Trials BB-CC).

With continued reference to FIG. 6, to test whether a smoother coating would improve resuspension of the magnetizable particles, the magnetic cores of 1×15 mm commercially available magnetic stirring elements were excised and repackaged inside either a glass tube or Teflon tubing, as described below. A 1×12 mm magnetic core was excised and repackaged inside either a glass (1.1 mm inside×1.6 mm outside diameter×15.5 mm length) (FIG. 6, Trials AA-BB) or Teflon (1.1 mm inside×1.7 mm outside diameter×16 mm length) (FIG. 6, Trials CC-DD) tubing and sealed with epoxy. Magnetizable particles in a 2 mL to 8 mL volume of fluid were resuspended at a rate of 99.5% to 101.9% in as little as 10 to 20 seconds at speeds of 360 RPM. These speeds provided a shallow meniscus that eased sampling with the probe with the modified magnetic stirring element (FIG. 6, Trials AA-DD). Furthermore, even after the magnetizable particles had been bound for six months to the modified magnetic stirring elements having repackaged cores, resuspension of the magnetizable particles occurred within seconds (FIG. 6, Trials BB-CC). By contrast, the same commercially available magnetic stirring element in its original Teflon® coating only resuspended at a rate of 87% after as long as 12 minutes of stirring (FIG. 5, Trial P), a length of time impractical for automated clinical analyses.

With continued reference to FIG. 6, in another trial, a custom 1×15 mm rod-shaped magnetic stirring element with square ends consisting of Arnokrome3 [Group Arnold, Marengo, Ill.] (Br 9000 Gauss: Hc 300 Oersted) was tested at 360 RPM. The magnetic stirring elements were of appropriate magnetic strength and functioned well in the test vessel, with a Teflon®-like coating or with no coating at all. The custom magnetic stirring element completely resuspended the magnetizable particles bound to the magnetic stirring element in 10 seconds (FIG. 6, Trials EE-FF).

Stability studies indicate that the Arnokrome3 material is corrosion resistant in ordinary buffer solutions and does not require a coating. A 1×15 mm magnetic stirring element in a 19 mm vessel filled up to 27 mm in height (about 8 mL volume) accomplished the desired rapid resuspension of magnetizable particles when speeds of 360 RPM were used. A shallow meniscus enabled reliable and consistent sampling by the probe. The custom magnetic stirring element has a magnetic strength of about 9,000 Gauss that is balanced in relation to the magnetic strength of the magnetic field driver. The magnetic stirring element is of sufficient length (15 mm) to sweep up the settling magnetizable particles and the thin bar (1 mm) produced a shallow meniscus during stirring when used in a vessel with an interior diameter of 19 mm, a range of fluid medium volume from 2 μL to 8 mL, at rotational speeds of 360 RPM.

What we claim is:

1. A kit for clinical analysis, comprising:
a) magnetizable particles;
b) a magnetic stirring element; and
c) a vessel, wherein said magnetizable particles and said magnetic stirring element are disposed within said vessel.

2. The kit of claim 1, wherein the kit further comprises one or more reagents.

3. The kit of claim 2 further comprising a fluid medium.

4. The kit of claim 2, wherein the one or more reagents are bound to one or more magnetizable particles.

5. The kit of claim 2 wherein the one or more reagents comprise an antibody or a portion of an antibody.

6. The kit of claim 2 wherein the one or more reagents comprise a tracer.

7. The kit of claim 6 wherein the tracer is selected from the group consisting of acridinium ester, fluorescein, rhodamine, gold particles, horseradish peroxidase, isoluminol, glucose oxidase, alkaline phosphatase, a labeled molecule such as labeled biotin, labeled avidin, a labeled antibody, and an unlabeled antibody.

8. The kit of claim 1 wherein the magnetizable particles are reversibly bound to the magnetic stirring element.

9. A device for distributing magnetizable particles in a fluid, comprising:
a) a platform for supporting a vessel containing a fluid of magnetizable particles; and
b) a magnetic stirring element disposed in said vessel with said magnetizable particles.

10. The device of claim 9, wherein the magnetic stirring element is rod-shaped.

11. The device of claim 9, wherein the diameter of the magnetic stirring element is about 3% to about 15% of the length of the magnetic stirring element.

12. The device of claim 9, wherein the diameter of the magnetic stirring element is about 5% to about 8% of the length of the magnetic stirring element.

13. The device of claim 9, wherein the length of the magnetic stirring element is about 60% to about 95% of a cross-sectional dimension of the vessel.

14. The device of claim 9, wherein the length of the magnetic stirring element is about 70% to about 80% of a cross-sectional dimension of the vessel.

15. The device of claim 9, wherein the magnetic stirring element has a magnetic strength of about 2000 to about 13,000 Gauss.

16. The device of claim 9, wherein the magnetic stirring element has a magnetic strength of about 8000 to about 10,000 Gauss.

17. The device of claim 9, wherein the magnetic stirring element comprises a smooth outer surface.

18. The device of claim 9, wherein the magnetic stirring element comprises an outer coating.

19. The device of claim 18, wherein the outer coating is glass.

20. The device of claim 18, wherein the outer coating is polytetraflouroethylene.

21. The device of claim 9, wherein the magnetic stirring element comprises a winged end.

22. The device of claim 9, wherein the magnetic stirring element comprises a round end.

23. The device of claim 9, wherein the magnetic stirring element comprises a square end.

24. The device of claim 9, wherein the magnetic stirring element is dumbell-like in shape, where a portion of the ends have a greater diameter than the center.

25. The device of claim 9 further comprising a processor.

26. The device of claim 9 further comprising a vessel transport rack.

27. The device of claim 9 further comprising a reagent transfer probe.

28. A method for distributing magnetizable particles in a fluid, comprising the steps of:
a) providing a vessel comprising a magnetic stirring element and a fluid containing magnetizable particles;
b) moving said magnetic stirring element in the vessel; and
c) distributing the magnetizable particles in the fluid.

29. The method of claim 28, further comprising applying a magnetic field to the magnetic stirring element in the vessel.

30. The method of claim 28 wherein moving the magnetic stirring element comprises rotating the magnetic stirring element.

31. The method of claim 28 further comprising the step of performing an immunoassay wherein said method of distributing said magnetizable particles in a fluid in performing said immunoassay is automated and controlled by a computer.
